(19) United States
(12) Patent Application Publication
(10) Pub. No.: US 2010/0071920 A1
(43) Pub. Date: Mar. 25, 2010

(54) POWER TOOL

(76) Inventors: James Ching Sik LAU, Hong Kong (CN); Duncan Yiu Lung Wong, Hong Kong (CN); Chang Lin Jin, Shenzhen (CN); Aloys J. Liu, Shenzhen (CN)

Correspondence Address: Muncy, Geissler, Olds & Lowe, PLLC, P.O. BOX 1364, FAIRFAX, VA, 22038-1364, US

(21) Appl. No.: 12/562,882

(22) Filed: Sep. 18, 2009

(30) Foreign Application Priority Data
Sep. 19, 2008 (CN) 200810216255.6

(51) Int. Cl. B23B 45/02; B25F 5/00

(52) U.S. Cl. 173/1; 173/170

(57) ABSTRACT

A power tool has a power head 11; a motor 10 configured to drive the power head; a handle 13 at which a switch 30 and a trigger 31 are installed; a force sensor 33 installed at the handle and electrically connected to the switch and configured to output voltage in response to force acted thereon; and a control unit configured to control the motor in response to the output voltage from the force sensor. A method for operating a power tool is also disclosed.

### CROSS REFERENCE TO RELATED APPLICATIONS

This non-provisional patent application claims priority under 35 U.S.C. §119(a) from Patent Application No. 200810216255.6 filed in The People's Republic of China on Sep. 19, 2008.

### FIELD OF THE INVENTION

This invention relates to power tools and in particular, to a power tool having force sensing components.

### BACKGROUND OF THE INVENTION

Drills are a typical kind of power tool widely used in industry or home. As shown in FIG. 4, a known power tool 10 in the form of a drill usually comprises a power head 11 in the form of a chuck for holding drills etc, a motor 12 for driving the power head 11, a handle 13, a battery 14 for providing a source of power to the motor 12 and other electric components, a switch 30 a installed at the handle 13, a trigger 31 for activating the switch and an enclosure 15. When a user holds the handle 13 and turns on the switch 30 by pushing the trigger 31, the motor 12 is activated to drive the power head 11. However, often a user is not ready to use the drill at the moment of holding the handle of the drill. As such, the user especially an inexperienced user may be scared when the drill works before he/she is ready. Furthermore, output of the motor is not being used efficiently, which results in waste of energy

### SUMMARY OF THE INVENTION

Hence there is a desire for an improved power tool.

Accordingly, in one aspect thereof, the present invention provides a power tool comprising: a power head; a motor configured to drive the power head; a handle accommodating a switch and a trigger; a force sensor fitted to the handle and electrically connected to the switch, the force sensor being configured to output a signal in response to force acting thereon; and a control unit configured to control the motor in response to the signal from the force sensor.

Preferably, the power tool further comprises an enclosure enclosing the motor and forming the handle, wherein the enclosure defines an opening for the force sensor to facilitate the force sensor sensing a force applied by a user.

Preferably, the opening is covered by a cover made of soft material.

Preferably, the soft material comprises rubber.

Preferably, the control unit comprises a comparison device configured to compare the value of the signal from the force sensor with preset values stored therein, and a signal amplifier configured to output a corresponding value of voltage/current to the motor in response to the result of the comparison.

Preferably, the signal from the force sensor is a voltage signal.

Preferably, the control unit is installed in the switch.

Preferably, the switch is activated when the trigger is depressed.

According to a second aspect, the present invention provides a method of operating a power tool which comprises a motor and a handle accommodating a switch, a trigger and a force sensor, the method comprising: holding the handle of the power tool and operating the trigger to activate the switch and bring the power tool into a state ready for working; and applying a force to the force sensor by pushing on a portion of the handle to start the motor.

Preferably, the method includes increasing the force acting on the force sensor by pushing harder, to increase the power output from the motor.

Preferably, the method includes decreasing the force acting on the force sensor by pushing less on the handle, to reduce the power output from the motor.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labelled with a same reference numeral in all the figures in which they appear. Dimensions of components and features shown in the figures are generally chosen for convenience and clarity of presentation and are not necessarily shown to scale. The figures are listed below.

FIG. 1 illustrates a power tool, in the form of a drill, in accordance with a first embodiment of the present invention;

FIG. 2 is an enlarged view of a portion of the power tool of FIG. 1;

FIG. 3 is a schematic block diagram of an electronic circuit of the power tool of FIG. 1; and

FIG. 4 illustrates a known power tool in the form of a drill.

### DETAILED DESCRIPTION OF THE PREFERRED EMBODIMENTS

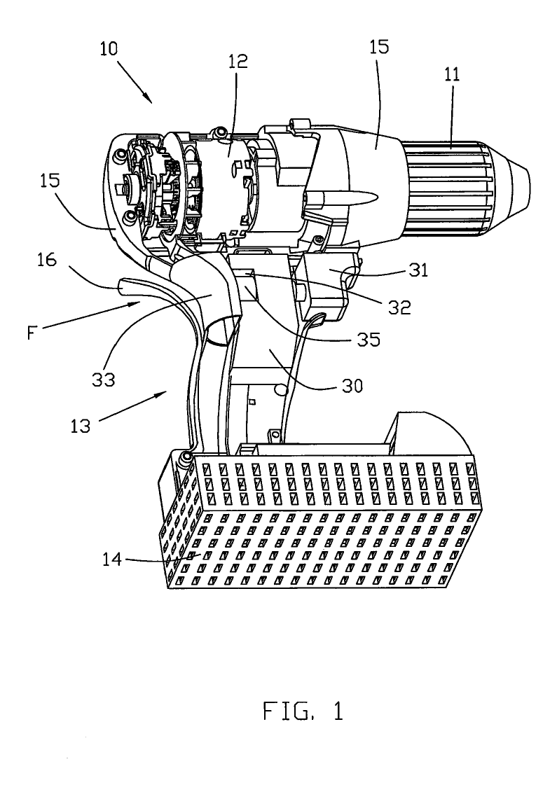

The power tool 10 of FIG. 1 is a drill having a power head 11, a motor 12, a power source 14, and an enclosure 15 for enclosing the motor 12 and which forms a handle 13. The handle 13 has installed therein a power switch 30 and a trigger 31 connected to the switch 30. The switch 30 has a locating slot 32. A pin 35 of a force sensor 33 is inserted in the locating slot 32 and is electrically connected to the switch 30. A heat sink (not shown) may be installed in the handle 13 contacting with the force sensor 33 and/or switch 30 for facilitating heat dissipation there from. The power source 14 is adapted to provide electric power to the motor 12, the switch 30, the force sensor 33 and other electric components. The power source 14 may be a battery accommodated within a housing attached to one end of the handle 13.

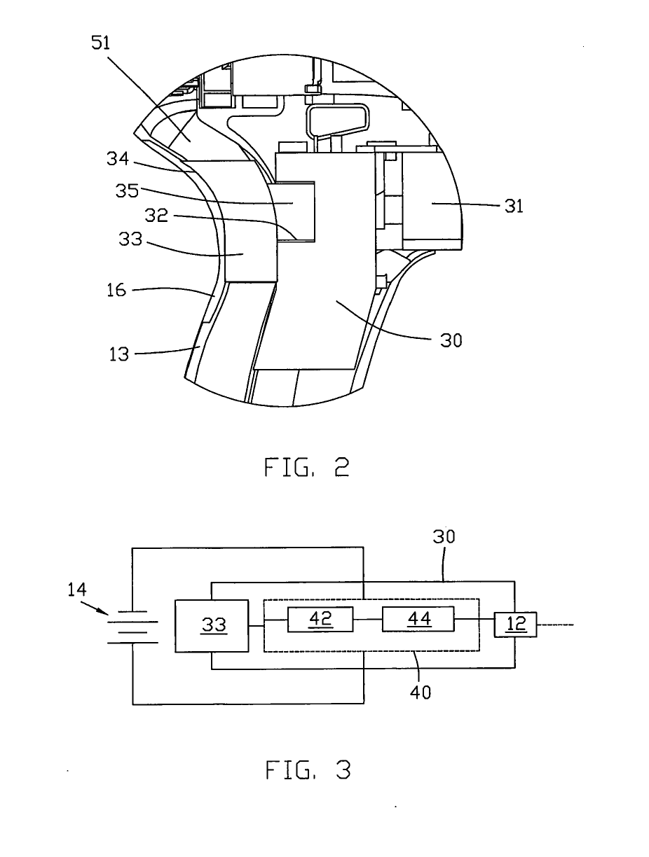

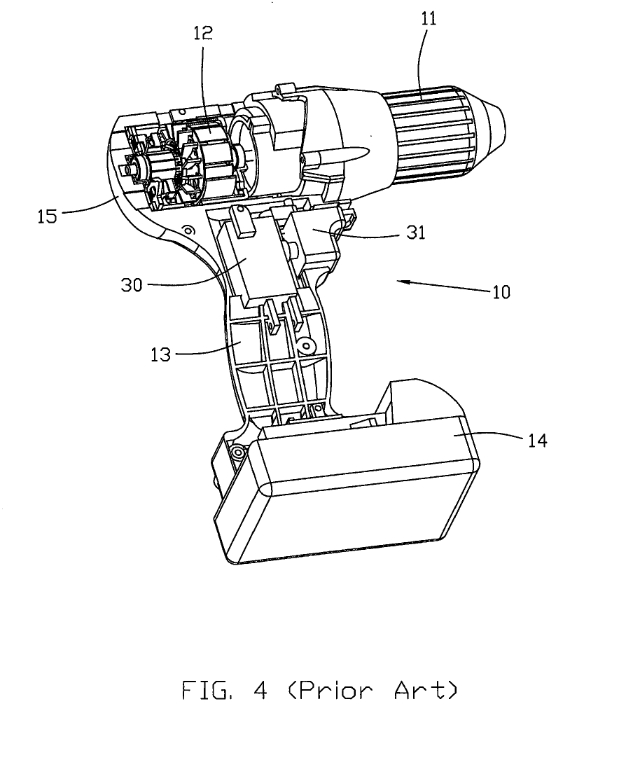

An enlarged view of the switch 30 and surrounding components is shown in FIG. 2, which is an enlargement of a portion of the power tool of FIG. 1. The enclosure 15 may be made of a plastics material and is preferably injection molded. The enclosure 15 defines an opening 51 corresponding to the force sensor 33. The force sensor 33 comprises a sensing surface 34 and the pin 35. The sensing surface 34 may extend outwardly through the opening 51. A cover 16 which may be attached to the enclosure 15, covers the opening 151 and the force sensor 33. Preferably, the cover 16 closely contacts the sensing surface 34 of the force sensor 33. The cover 16 may be made of soft material for example, rubber, such that force acting on the cover 16 is transferred to the sensing surface 34 of the force sensor 33. The cover 16 may absorb shock when the power tool 10 works. The pin 35 of the force sensor 33 is inserted into the locating slot 32 of the power switch 30 to thereby retain the force sensor 33 to the switch 30. When a force F acts on the outer surface of the cover 16, the force F is transferred to the sensing surface 34. Consequently, the force sensor 33 will generate a voltage signal corresponding to the magnitude of the applied force F.

Referring to FIG. 3, the power switch 30 comprises a control unit 40 which comprises a comparison device 42 and a signal amplifier 44. A group of voltages V₁, V₂ . . . Vₙ are preset in the comparison device. The increasing force applied to the cover 16 may be presented as F₀, F₀*(1+y), F₀*(1+2y), . . . F₀*(1+ny), the corresponding voltage signal generated by the force sensor is represented as V₀, V₀*(1+x), V₀*(1+2x), . . . V₀*(1+nx), wherein F₀ presents an initial holding force acting on the handle 13 when the user holds the handle of the power tool, V₀ presents an initial voltage value, y presents increased percentage of the force being applied to the cover 16, and x presents increased percentage of the value of the voltage signal generated by the force sensor. Usually, different users will apply different holding forces. However, the difference is not great and the holding force is usually in a common range. Therefore, the voltage V₁ may be preset to be much greater than the usual maximum initial voltage V₀ corresponding to the maximum holding force in the range.

In operation, a user holds the handle 13 of the power tool 10 and depresses the trigger 31 to activate the switch 30. The user applies to the cover 16 a holding force F₀. Consequently, the force sensor 33 outputs a voltage V₀ which is transferred to the comparison device 42. Since the voltage V₀ is much less than the preset voltage V₁, the control unit 40 of the power switch 30 keeps the motor turned off. When the user is ready to use the power tool, the user pushes the cover 16 in a predetermined direction and therefore applies an increased force F₀*(1+y), F₀*(1+2y), . . . F₀*(1+ny) on the cover 16. Accordingly, the force sensor 33 outputs a signal with an increased voltage V₀*(1+x), V₀*(1+2x), . . . V₀*(1+nx) to the comparison device 42 which compares the increased voltage with the preset voltage V₁, V₂ . . . Vₙ. When the voltage V₀*(1+x) is greater than the corresponding preset voltage V₁, the signal amplifier 44 outputs corresponding voltage/current to start the motor 12 which drives the power head 11, in response to signals from the comparator 42. When the voltage V₀*(1+nx) is greater than the corresponding preset voltage value Vn, the signal amplifier 44 outputs correspondingly increased voltage/current to the motor 12 which results in the motor 12 outputting correspondingly increased power. Understandably, when the user reduces the force applied to the cover 16, the signal amplifier 44 outputs correspondingly decreased voltage/current to the motor 12 which results in the motor 12 outputting correspondingly reduced power. When the decreased voltage output from the force sensor 33 is less than the preset voltage V₁, the control unit 40 will switch the motor off. Thus the motor is controlled by the force that the user applies to that portion of the power tool corresponding to the force sensor.

In the preferred embodiment of the present invention, the motor of the power tool does not work at the moment the user holds the handle of the power tool. Instead the motor does not start until the user consciously increases the force acting on the handle, to thereby avoid scaring and/or damaging the user and wasting of energy.

In the present invention, the power tool may be cordless drills, drills, scissors, screwdrivers etc. Optionally, the control unit can control the rate of increase in speed or power out of the motor in response to an increase or decrease in the force applied to the power tool.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

For example, the output from the force sensor is described as a voltage signal, but other types of signals, such as a current signal or a digital signal may be used and it is the value of the output signal which the comparison device compares with predetermined or stored values in order to control the operation of the motor.

1. A power tool comprising:
a power head;
a motor configured to drive the power head;
a handle accommodating a switch and a trigger;
a force sensor fitted to the handle and electrically connected to the switch, the force sensor being configured to output a signal in response to force acting thereon; and
a control unit configured to control the motor in response to the signal from the force sensor.

2. The power tool of claim 1, further comprising an enclosure enclosing the motor and forming the handle, wherein the enclosure defines an opening for the force sensor to facilitate the force sensor sensing a force applied by a user.

3. The power tool of claim 2, wherein the opening is covered by a cover made of soft material.

4. The power tool of claim 3, wherein the soft material comprises rubber.

5. The power tool of claim 1, wherein the control unit comprises a comparison device configured to compare the value of the signal from the force sensor with preset values stored therein, and a signal amplifier configured to output a corresponding value of voltage/current to the motor in response to the result of the comparison.

6. The power tool of claim 5, wherein the signal from the force sensor is a voltage signal.

7. The power tool of claim 5, wherein the control unit is installed in the switch.

8. The power tool of claim 1, wherein the switch is activated when the trigger is depressed.

9. A method of operating the power tool of claim 1, the method comprising:
holding the handle of the power tool and operating the trigger to activate the switch and bring the power tool into a state ready for working; and
applying a force to the force sensor by pushing on a portion of the handle to start the motor.

10. The method of claim 9, further comprising increasing the force acting on the force sensor by pushing harder, to increase the power output from the motor.

11. The method of claim 10, further comprising decreasing the force acting on the force sensor by pushing less on the handle, to reduce the power output from the motor.
